(19) United States
(12) Patent Application Publication
(10) Pub. No.: US 2020/0070525 A1
(43) Pub. Date: Mar. 5, 2020

(54) INK JET PRINTER

(71) Applicant: SEIKO EPSON CORPORATION, Tokyo (JP)

(72) Inventors: Yasushi YAJIMA, Kamiina-gun Minowa-machi (JP); Hiroyuki KOBAYASHI, Suwa-gun Shimosuwa-machi (JP)

(21) Appl. No.: 16/555,544

(22) Filed: Aug. 29, 2019

(30) Foreign Application Priority Data
Aug. 31, 2018 (JP) 2018-162586

(51) Int. Cl. B41J 2/175

(52) U.S. Cl. CPC B41J 2/17513; B41J 2/17509; B41J 2/17523

(57) ABSTRACT

An ink jet printer includes a head having a nozzle from which ink is ejected, a tank main body portion in which the ink to be supplied to the head is reserved, and a carriage on which the head and the tank main body portion are mounted and which moves along a guide member, in which the carriage has a left wall portion at a +X direction side, out of +X direction in which the carriage moves, with respect to a supply port through which an inside of the tank main body portion and an outside of the tank main body portion communicate with each other, and the supply port and the left wall portion overlap with each other as viewed from the X-axis direction in which the carriage moves.

The present application is based on, and claims priority from JP Application Serial Number 2018-162586, filed Aug. 31, 2018, the disclosure of which is hereby incorporated by reference herein in its entirety.

### BACKGROUND

The present disclosure relates to an ink jet printer.

A liquid ejecting device using a recording head that ejects droplets is known.

An ink jet printer described in JP-A-2016-68510 includes a droplet ejector configured to move and a reservoir in which ink is reserved, and the droplet ejector and the reservoir contact with each other when a moving direction of the droplet ejector changes, so that the ink is directly supplied from the reservoir to the droplet ejector.

Specifically, the liquid ejector includes a carriage, a recording head ejecting ink, and a sub-tank supplying ink to the recording head and is configured to move. The reservoir includes an ink injection portion supplying ink to the sub-tank. If the droplet ejector moves to a home position, the sub-tank of the droplet ejector and the ink injection portion of the reservoir are coupled to each other so that ink is directly supplied from the ink injection portion to the sub-tank. If the droplet ejector moves from the home position, the sub-tank of the droplet ejector and the ink injection portion of the reservoir are spaced apart and ink is not injected into the sub-tank from the ink injection portion.

In this configuration, it is not necessary to couple the reservoir to the droplet ejector with an ink tube or the like so that it is possible to downsize an ink jet printer.

### SUMMARY

However, in the ink jet printer described in JP-A-2016-68510, coupling and decoupling are repeated, ink is injected from the ink injection portion into the sub-tank intermittently, and unnecessary ink adheres to the ink injecting port of the sub-tank sometimes. Further, there is a concern that, since the ink injecting port is provided on a side surface of the sub-tank, the unnecessary ink adhering to the ink injecting port contaminates a roll paper sheet.

An ink jet printer according to the present disclosure includes a head having a nozzle from which ink is ejected, an ink reservoir in which the ink supplied to the head is reserved, and a carriage on which the head and the ink reservoir are mounted configured to move along a guide member, in which the carriage has a first wall portion positioned at a position that is in a first direction from a supply port through which an inside of the ink reservoir and an outside of the ink reservoir communicate with each other, the first direction being along a direction in which the carriage moves, and the supply port and the first wall portion overlap with each other as viewed in the direction in which the carriage moves.

The ink jet printer according to another aspect of the present disclosure may include a transporter configured to transport a medium onto which the ink is ejected and a controller configured to control movement of the carriage. And when the ink is supplied through the supply port to the ink reservoir, the controller may be configured to control the carriage to move to an ink supply position. In a state where the carriage is positioned in the ink supply position, an area through which the medium transported by the transporter passes may be positioned at a position that is in the first direction from a nozzle surface.

The ink jet printer according to another aspect of the present disclosure may include a transporter configured to transport a medium onto which the ink is ejected and a controller configured to control the movement of the carriage. And when the ink is supplied through the supply port to the ink reservoir, the controller may be configured to control the carriage to move to an ink supply position. In a state where the carriage is positioned in the ink supply position, the nozzle surface of the head may be positioned at a position that is in the first direction from the area through which the medium transported by the transporter passes.

In the ink jet printer according to another aspect of the present disclosure, the carriage may have a second wall portion positioned at a position that is in a second direction from the supply port, the second direction being opposite to the first direction and along the direction in which the carriage moves. And the supply port and the second wall portion may overlap with each other as viewed in the direction in which the carriage moves.

In the ink jet printer according to another aspect of the present disclosure, the carriage may have a lid member covering a vertically upper side with respect to the supply port.

The ink jet printer according to another aspect of the present disclosure may include a controller configured to control the carriage to move to the ink supply position when the ink is supplied from the supply port to the ink reservoir, a printer case having an opening portion vertically above the carriage positioned in the ink supply position, and a printer cover that is provided on the printer case and that is configured to move to a covering position in which the opening portion is covered and an open position different from the covering position. The carriage may have a lid member positioned vertically above the supply port. The supply port may be positioned so that a user is able to access the supply port regardless of a state of the lid member when the printer cover is in the open position.

In the ink jet printer according to another aspect of the present disclosure, the ink reservoir may have a protruding portion on a vertically upper surface, the supply port may be provided on the protruding portion, and the protruding portion and the first wall portion may overlap with each other as viewed in the direction in which the carriage moves, and the protruding portion and the second wall portion may overlap with each other as viewed in the direction in which the carriage moves.

In the ink jet printer according to another aspect of the present disclosure, the ink reservoir may have a recessed portion on the vertically upper surface, and the supply port may be provided in the recessed portion.

The ink jet printer according to another aspect of the present disclosure may include a cap member which is inserted into the supply port and at least a part of which protrudes from the recessed portion, and the part of the cap member protruding from the recessed portion and the first wall portion may overlap with each other as viewed in the direction in which the carriage moves.

In the ink jet printer according to the aspect of the present disclosure, the carriage may have a third wall portion positioned at a position that is in a third direction from the ink reservoir, the third direction intersecting with the vertical direction and with the direction in which the carriage moves, and an upper end of the third wall portion in the vertical direction may be positioned lower than the upper end of the first wall portion in the vertical direction.

### BRIEF DESCRIPTION OF THE DRAWINGS

FIG. 1 is a perspective view of an ink jet printer according to an embodiment 1.

FIG. 2 is a perspective view of an inkjet printer according to a modification example.

FIG. 3 is a sectional view of the inkjet printer according to the embodiment 1.

FIG. 4 is a perspective view of the ink jet printer according to the embodiment 1.

FIG.5 is a perspective view showing a state of a carriage according to the embodiment 1.

FIG. 6 is a sectional view of the inkjet printer according to the embodiment 1.

FIG. 7 is a sectional view of an ink jet printer according to an embodiment 2.

### DESCRIPTION OF EXEMPLARY EMBODIMENTS

In the following, embodiments of the present disclosure will be described with reference to drawings. Such embodiments show aspects of the present disclosure and the present disclosure is not limited thereto. Any modification is possible within a scope of technical ideas of the present disclosure. Further, in each of following drawings, scale of each layer or each part is made different from actual scale to make each layer or each part recognizable in the drawings.

### Embodiment 1

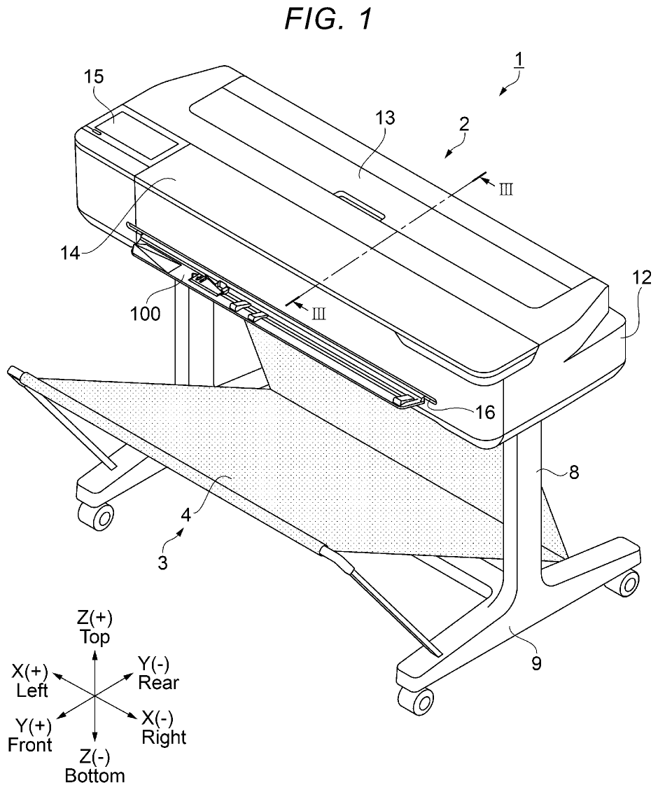

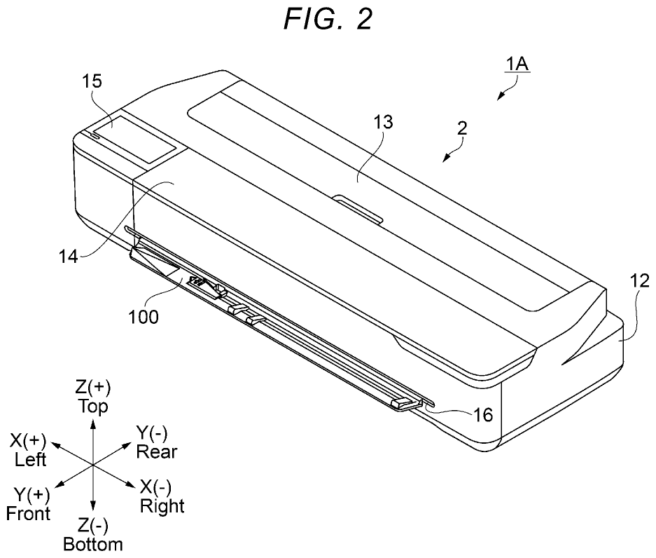

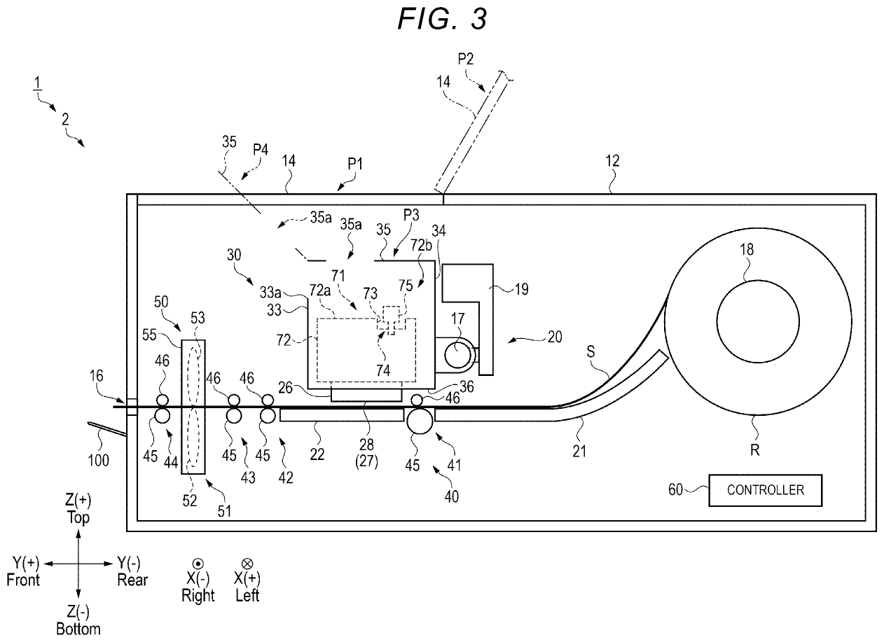

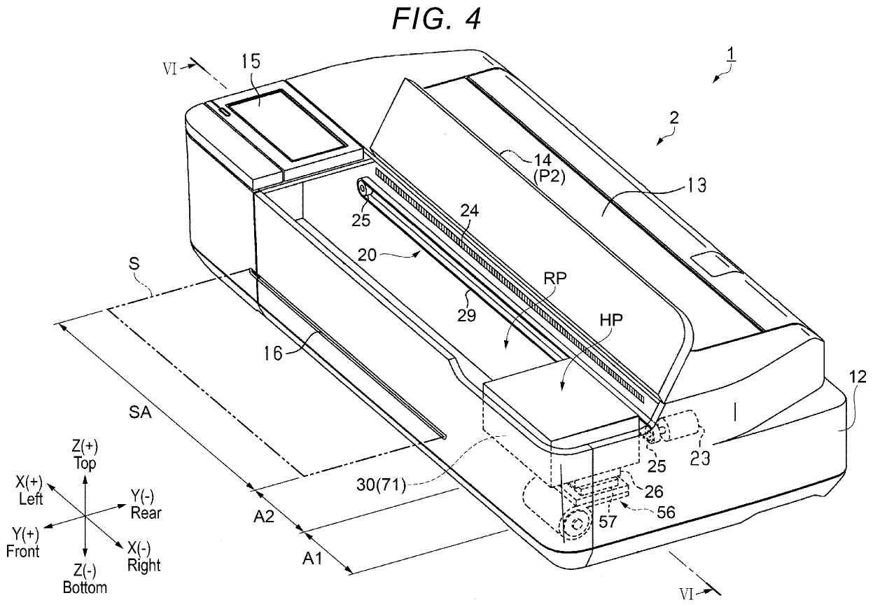

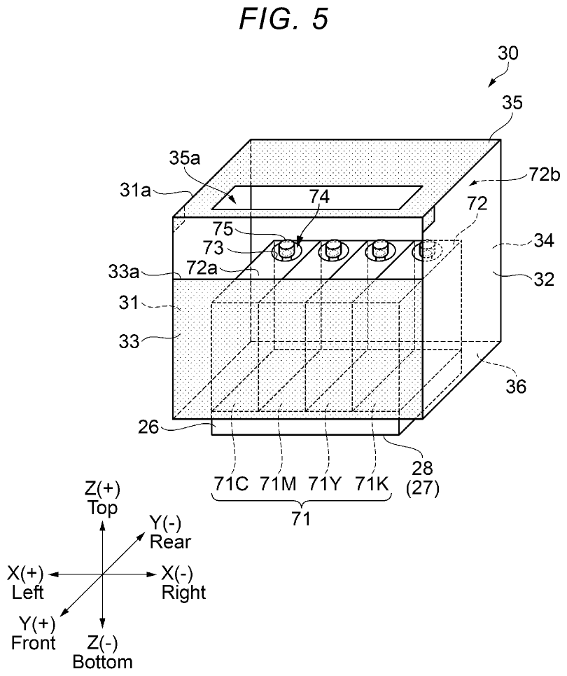

FIGS. 1 and 4 are perspective views of a printer 1 as an ink jet printer according to an embodiment 1. FIG. 2 is a perspective view of a printer 1A as an ink jet printer according to a modification example. FIG. 3 is a sectional view of the ink jet printer according to the embodiment 1. FIG. 5 is a perspective view showing a state of a carriage 30.

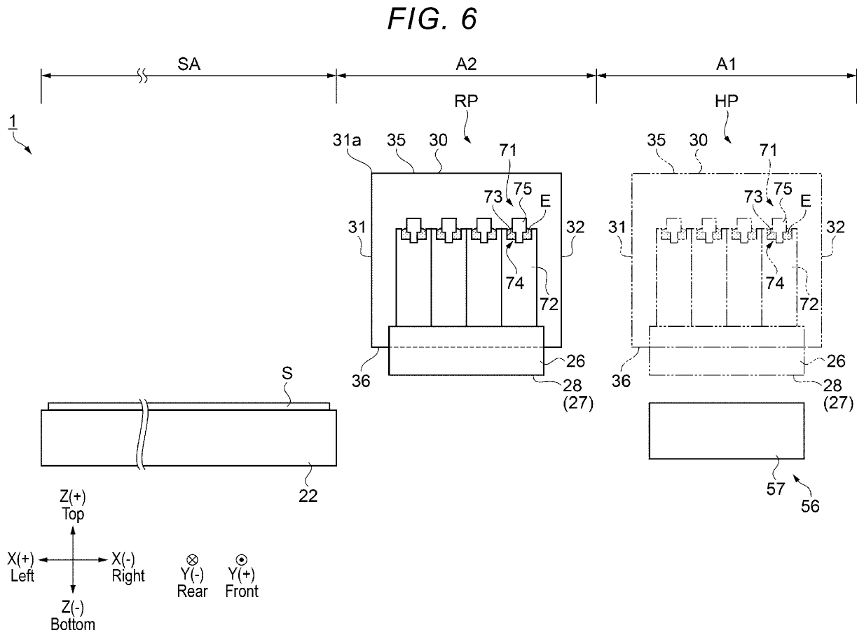

FIGS. 1 to 4 show the printer 1 placed on a horizontal surface. FIG. 3 is a sectional view taken along line in FIG. 1, and a state of a main body 2 of the printer 1 is schematically shown. Further, FIGS. 1 to 3 show states where a maintenance cover 14 is closed, that is, states where the maintenance cover 14 is in a covering position P1. FIG. 4 shows a state where the maintenance cover 14 is opened, that is, a state where the maintenance cover 14 is in an open position P2. In FIG. 5, a front wall portion 33 and an upper wall portion 35 are shaded and the other wall portions 31, 32, 34, and 36 are not shaded. Further, FIG. 5 shows a head 26 and an ink tank 71 mounted on the carriage 30 in addition to the carriage 30. FIG. 6 is a sectional view taken along line VI-VI of FIG. 4 and is a schematic view showing a state of the ink jet printer according to the present embodiment.

Further, in the following description, a width direction of the printer 1 is referred to as X-axis direction, a depth direction of the printer 1 is referred to as Y-axis direction, and a height direction of the printer 1 is referred to as Z-axis direction. X-axis and Y-axis directions are directions along a horizontal plane, and Z-axis direction is a vertical direction orthogonal to the horizontal plane.

Further, of the X-axis direction, the direction toward one side is a +X direction and the direction toward the other side is a −X direction. Of the Y-axis direction, the direction toward one side is a +Y direction and the direction toward the other side is a −Y direction. Of the Z-axis direction, the direction toward one side is a +Z direction and the direction toward the other side is a −Z direction. In the present embodiment, the +X direction is a leftward direction, the −X direction is a rightward direction, the +Y direction is a frontward direction, the −Y direction is a rearward direction, the +Z direction is an upward direction, and the −Z direction is a downward direction. In the drawings, the +X direction, the -X direction, the +Y direction, the −Y direction, the +Z direction, and the −Z directions are denoted by X(+), X(−), Y(+), Y(−), Z(+), and Z(−).

In the present embodiment, the X-axis direction is a direction in which the carriage 30 moves. Further, in the present embodiment, the +X direction is one of a first direction and a second direction out of the directions in which the carriage 30 moves and −X direction is the other of the first direction and the second direction. Further, Y-axis direction is a direction intersecting with the vertical direction and the moving direction of the carriage, and one side of the Y-axis direction is a +Y direction side. As described above, Z-axis direction is the vertical direction and +Z direction is a vertically upward direction.

As shown in FIG. 1, the printer 1 according to the present embodiment is a printer configured to form an image on a paper sheet S as a medium. The printer 1 is a printer configured to form an image also on a medium of a relatively large size such as A0 size or B1 size of JIS standard, for example, as a paper sheet S. Further, the printer 1 is configured to form an image on a cut paper sheet of A4 size or the like as a paper sheet S.

The printer 1 includes the main body 2 and a discharged paper sheet receiver 3. The main body 2 is provided in an upper portion, which is a part on the +Z direction side of a column 8 erected on a base 9. The discharged paper sheet receiver 3 has a paper sheet collection portion 4. The paper sheet collection portion 4 is provided below the main body 2 and catches a paper sheet S discharged from the main body 2 side.

As shown in FIG. 2, the inkjet printer according to the present embodiment may be a printer 1A configured with the main body 2 alone without the discharged paper sheet receiver 3. That is, the ink jet printer according to the present embodiment may be a desktop type printer 1A configured to be installed on a desk or the like.

As shown in FIG. 1, the main body 2 includes an approximately rectangular parallelepiped printer case 12. A paper sheet cover 13 positioned at the −Y direction side and a maintenance cover 14 as a printer cover positioned at the +Y direction side are provided, configured to open and close, on an upper surface, which is a surface on the +Z direction side, of the printer case 12. An operation panel 15 for the performance of various operations of the printer 1 by a user is provided on the +X direction side of the maintenance cover 14 on the upper surface on the printer case 12. Then, a paper sheet discharge port 16 is provided, configured to discharge a paper sheet S on which an image is recorded in the printer case 12 toward the +Y direction side, on a front surface, which is a side surface on the +Y direction side, of the printer case 12. A paper sheet discharge portion 100 supporting a paper sheet S discharged from the paper sheet discharge port 16 is provided on the −Z direction side of the paper sheet discharge port 16.

As shown in FIG. 3, a roll body R into which a paper sheet S is wound in a roll shape is disposed in the printer case 12. The roll body R is rotatably supported by a shaft 18 extending in the X-axis direction as the width direction of the paper sheet S. In the present embodiment, the paper sheet S is unwound from the roll body R by a rotation of the shaft 18 in a counterclockwise direction in FIG. 3. The unwound paper sheet S is transported by a transporter 40, passes through the paper sheet discharge port 16 opening on the front surface of the printer case 12 and is discharged to the outside of the printer case 12. A path through which the unwound paper sheet S is transported to the paper sheet discharge port 16 by the transporter 40 is a transport path, and the direction from right to left in FIG. 3, that is, the direction from −Y direction side toward +Y direction side, is the transport direction of the paper sheet S transported by the transporter 40. The transport direction in the present embodiment is a direction along the transport path and is not limited to a linear direction.

A recorder 20 is provided in the printer case 12. The recorder 20 includes a head 26 as an ink jet head ejecting a liquid, ink and the like, for example, toward the paper sheet S, an ink tank 71, a guide shaft 17 as a guide member, and a carriage 30.

Further, as shown in FIG. 4, the recorder 20 has a motor 23 providing a driving force that enables the carriage 30 to move, an encoder 24 detecting a position of the carriage 30, a pair of pulleys 25, and a timing belt 29 which is wound around the pair of pulleys 25 and a part of which is fixed to the carriage 30. When the motor 23 is driven forward and backward, the carriage 30 reciprocates in the X-axis direction, and speed control and position control of the carriage 30 are performed based on a pulse signal output from the encoder 24.

As shown in FIG. 3, the guide shaft 17 is of a straight line shape extending in the X-axis direction as the width direction of the paper sheet S. The guide shaft 17 is supported by a frame 19 provided in the printer case 12.

The carriage 30 is supported by the guide shaft 17 and is configured to move along the guide shaft 17. The head 26 and the ink tank 71 are mounted on the carriage 30. Then, the head 26 and the ink tank 71 are configured to move in the X-axis direction together with the carriage 30.

The head 26 is positioned at a position that is in the −Z direction from the ink tank 71. The head 26 includes a nozzle surface 28 on which a nozzle 27, through which the ink is ejected, is formed. The nozzle surface 28 is a surface on the −Z direction side of the head 26 and is disposed so as to protrude in the −Z direction from a lower wall portion 36 which is a wall portion of the carriage 30 on the −Z direction side. The head 26 has a pressure generation chamber (not shown), a piezoelectric element (not shown), and a nozzle 27. The nozzle 27 passes through a flow path (not shown) provided in the head 26 and communicates with the ink tank 71. The piezoelectric element is a piezoelectric actuator in a flexural vibration mode or a piezoelectric actuator in a longitudinal vibration mode. The piezoelectric element vibrates a vibration plate forming a part of the pressure generation chamber, generates pressure changes in the pressure generation chamber, and ejects ink from the nozzle 27 onto the paper sheet S using the pressure changes.

The ink tank 71 is positioned at a position that is in the +Z direction from the head 26. The ink tank 71 is accommodated in the carriage 30.

As shown in FIG. 5, in the present embodiment, four ink tanks 71 are accommodated in the carriage 30. Any of the four color inks composed of cyan ink, magenta ink, yellow ink, and blank ink is reserved in the four ink tanks 71. That is, an ink tank 71C in which cyan ink is reserved, an ink tank 71M in which magenta ink is sored, an ink tank 71Y in which yellow ink is reserved, and an ink tank 71K in which blank ink of reserved are accommodated in the carriage 30.

The number of ink tanks 71 accommodated in the carriage 30 may be less than four and may be more than four. Further, the number of ink colors may be less than four and may be more than four.

Further, the ink reserved in the ink tank 71 will be referred to as ink E in the following description.

As shown in FIG. 3, the ink tank 71 has a tank main body portion 72 as an ink reservoir and a cap member 75.

The tank main body portion 72 is a hollow container and reserves the ink E. A recessed portion 73 is provided on a surface 72a on the +Z direction side of the tank main body portion 72. A supply port 74 passing through the surface 72a is provided in the recessed portion 73. That is, the tank main body portion 72 has the recessed portion 73 on the surface 72a on the +Z direction side, and the supply port 74 is provided in the recessed portion 73. The inside of the tank main body portion 72 and the outside of the tank main body portion 72 communicate with each other through the supply port 74.

In other words, the printer 1 of the present embodiment includes the carriage 30 on which the head 26, having the nozzle 27 through which the ink E is ejected, and the tank main body portion 72, in which the ink E to be supplied to the head 26 is reserved, are mounted and which is configured to move along the guide shaft 17. Further, the supply port 74 through which the inside of the tank main body portion 72 and the outside of the tank main body portion 72 communicate with each other is provided in the tank main body portion 72.

In addition, the tank main body portion 72 has the recessed portion 73 on the surface 72a on the +Z direction side and the supply port 74 is provided in the recessed portion 73 in the present embodiment.

The cap member 75 is inserted into the supply port 74 and prevents an intrusion of a foreign matter into the ink E and drying of the ink E reserved in the tank main body portion 72. Further, an atmosphere communication hole (not shown) is provided in the tank main body portion 72 so that the atmospheric pressure is maintained inside the tank main body portion 72.

In a state where the cap member 75 is inserted into the supply port 74, the surface on the +Z direction side of the cap member 75 protrudes from the recessed portion 73 to the +Z direction side. That is, the ink tank 71 includes the cap member 75. Then, the cap member 75 is inserted into the supply port 74 and at least a part thereof protrudes from the recessed portion 73 to the +Z direction side.

As will be described below in detail, the carriage 30 has an upper wall portion 35 disposed on the +Z direction side as a lid member. The upper wall portion 35 is configured to pivot at least in the Z-axis direction with an end on the +Y direction side as a fulcrum.

In FIG. 3, the maintenance cover 14 in a covering position P1 is shown with solid lines in the figure, the maintenance cover 14 in an open position P2 is shown with two-dot chain lines in the figure, the upper wall portion 35 in a covering position P3 is shown with a solid line in the figure, and the upper wall portion 35 in an open position P4 is shown with a two-dot chain line in the figure.

Then, the maintenance cover 14 is disposed in the covering position P1 if the user closes the maintenance cover 14, and the maintenance cover 14 is disposed in the open position P2 if the user opens the maintenance cover 14. Further, the upper wall portion 35 is disposed in the covering position P3 if the user closes the upper wall portion 35 and the upper wall portion 35 is disposed in the open position P4 if the user opens the upper wall portion 35.

Further, the user can observe the inside of the main body 2 if the maintenance cover 14 is disposed in the open position P2. Further, the user can access the ink tank 71 and the ink E can be supplied into the tank main body portion 72 if the maintenance cover 14 is disposed in the open position P2 and the upper wall portion 35 is disposed in the open position P4, that is, if the maintenance cover 14 and the upper wall portion 35 are opened. In the present embodiment, the user can supply the ink E into the tank main body portion 72 even in a state where the ink E is left inside the tank main body portion 72.

The tank main body portion 72 is transparent, and the user can observe the state of the ink E reserved in the tank main body portion 72.

If the printer 1 repeats the recording of images on the paper sheet S, the ink E reserved in the tank main body portion 72 is consumed and the ink E reserved in the tank main body portion 72 is reduced. If the user observes the state of the ink E reserved in the tank main body portion 72 and the ink E reserved in the tank main body portion 72 is reduced, the user moves the maintenance cover 14 from the covering position P1 to the open position P2 and further moves the upper wall portion 35 from the covering position P3 to the open position P4 to expose the cap member 75 and the supply port 74. The user detaches the cap member 75 and supplies the ink E into the tank main body portion 72 through the supply port 74 in a state where the cap member 75 and the supply port 74 are exposed.

Further, after ending the supply of the ink E to the tank main body portion 72, the user moves the upper wall portion 35 from the open position P4 to the covering position P3 and moves the maintenance cover 14 from the open position P2 to the covering position P1.

The ink E reserved in the tank main body portion 72 is water-based ink in which coloring material is dispersed or dissolved in an aqueous medium. In the present embodiment, a pigment is used as a colorant. The coloring material may be a dye.

A solvent is an aqueous medium, for example, and pure water or ultrapure water such as ion exchange water, ultrafiltered water, reverse osmosis water or distilled water is used. Further, when water sterilized by ultraviolet irradiation or addition of hydrogen peroxide is used, generation of mold and bacteria is prevented when the ink E is preserved for a long time. The solvent may contain a volatile water-soluble organic solvent such as ethylene glycol or propylene glycol.

Further, the ink E reserved in the tank main body portion 72 may contain a basic catalyst, a surfactant, a tertiary amine, resins, a pH adjuster, a buffer, a fixing agent, a preservative, an antioxidant/ultraviolet absorber, a chelate agent, an oxygen absorber, and the like.

A first support member 21 and a second support member 22 are configured with plate-shaped members. The first support member 21 is disposed upstream of the second support member 22 in the transport direction and guides the paper sheet S unwound from the roller body R toward the recorder 20. The second support member 22 is disposed to face the head 26 of the recorder 20.

The transporter 40 transports the paper sheet S, unwound from the roll body R, from inside the printer case 12 toward the paper sheet discharge port 16 along the first support member 21 and the second support member 22. The transporter 40 has a first transport roller pair 41, a second transport roller pair 42, a third transport roller pair 43, and a fourth transport roller pair 44, sequentially disposed from upstream toward downstream of the transport direction. The first transport roller pair 41 is positioned upstream of the head 26 in the transport direction and is disposed in a position between the first support member 21 and the second support member 22. The other transport roller pairs 42, 43, and 44 are disposed downstream of the head 26 in the transport direction.

The transport roller pairs 41, 42, 43, and 44 have driving rollers 45, configured to be driven and rotated by a motor (not shown), and driven rollers 46 configured to be driven with respect to the rotation of the driving rollers 45. The transport roller pairs 41, 42, 43, and 44 roll so as to transport the paper sheet S in a state where the driving rollers 45 and the driven rollers 46 pinch the paper sheet S. The driving rollers 45 are disposed so as to contact with the paper sheet S from the −Z direction side. The driven rollers 46 contacts with the paper sheet S from +Z direction side. That is, when the paper sheet S is transported, the driven rollers 46 in the transport roller pairs 42, 43, and 44 contact with the paper sheet S on a surface onto which a liquid is ejected. Therefore, to reduce deterioration of quality of an image recorded on the paper sheet S, the driven rollers 46 in the transport roller pairs 42, 43, and 44 are configured with star wheels or the like having small contact areas with respect to the paper sheet S. A plurality of transport roller pairs 41, 42, 43, and 44 are disposed at predetermined intervals in the X-axis direction.

A cutting mechanism 50 is disposed between the third transport roller pair 43 and the fourth transport roller pair 44. The paper sheet S cut by the cutting mechanism 50 is transported by the fourth transport roller pair 44 to be discharged from the paper sheet discharge port 16. The fourth transport roller pair 44 is positioned downstream of the transport direction with respect to the cutting mechanism 50 and is disposed in the vicinity of the paper sheet discharge port 16. Since the fourth transport roller pair 44 is disposed in the vicinity of the paper sheet discharge port 16, the paper sheet S is transported smoothly toward the paper sheet discharge port 16 and it is possible to prevent an occurrence of a paper jam.

Further, in the present embodiment, the dimension of the paper sheet discharge port 16 in the Z-axis direction is set to such an extent that a user cannot insert a finger from the paper sheet discharge port 16 into the printer case 12.

The cutting mechanism 50 includes a cutting blade 51 for cutting the paper sheet S and a holding body 55 that holds the cutting blade 51. The cutting blade 51 is configured with disk-shaped driving blade 52 and driven blade 53. The driving blade 52 and the driven blade 53 are attached to the holding body 55 in a rotatable state with respect to the holding body 55. The driving blade 52 and the driven blade 53 are arranged in a parallel in the vertical direction. The holding body 55 can reciprocate in the X-axis direction. By the movement of the holding body 55 in the X-axis direction, the cutting mechanism 50 cuts the paper sheet S by the cutting blade 51. That is, by scanning in the X-axis direction intersecting with the transport direction of the paper sheet S, the cutting mechanism 50 including the cutting blade 51 cuts the paper sheet S.

The cutting mechanism 50 may be configured to reciprocate in the X-axis direction by a driving force of a driving source such as a motor or the like or may be configured to be coupled with the carriage 30 and to reciprocate in the X-axis direction by a driving force of a driving source such as a motor that moves the carriage 30.

Further, a controller 60 controlling the movement of the carriage 30 is provided in the printer case 12.

The controller 60 includes a CPU (not shown), a memory (not shown), and the like. The CPU is a calculation processing device for performing control of the whole printer 1. The memory is a storage medium in which an area where a program to operate the CPU is stored and a work area where the program is operated are allocated and which includes storage elements such as a RAM and EPROM.

The controller 60 alternately repeats the operation of ejecting the ink E from the nozzle 27 onto the paper sheet S while moving the carriage 30 in the X-axis direction and the operation of moving the paper sheet S in the transport direction and controls the recorder 20 and the transporter 40 so that an image is recorded on the paper sheet S.

Next, states of the main body 2 of the printer 1 and the carriage 30 of the printer 1 will be described in further detail with reference to FIGS. 4 and 5.

As shown in FIG. 5, the carriage 30 has a left wall portion 31 disposed on the +X direction side, a right wall portion 32 disposed on the −X direction side, a front wall portion 33 disposed on the +Y direction side, a rear wall portion 34 disposed on the −Y direction side, an upper wall portion 35 disposed on the +Z direction side, and a lower wall portion 36 disposed on the −Z direction side.

The carriage 30 is a hollow member having the left wall portion 31, the right wall portion 32, the front wall portion 33, the rear wall portion 34, the upper wall portion 35, and the lower wall portion 36. The head 26 and the ink tank 71 are disposed inside of the carriage 30. That is, the left wall portion 31 as a first wall portion is positioned at a position that is in the +X direction from the supply port 74 provided in the tank main body portion 72 of the ink tank 71. Further, the right wall portion 32 as a second wall portion is positioned at a position that is in the −X direction from the supply port 74. Further, the front wall portion 33 as a third wall portion is positioned at a position that is in the +Y direction from the supply port 74. The upper wall portion 35 is positioned at a position that is in the +Z direction from the supply port 74. Further, the left wall portion 31, the right wall portion 32, and the upper wall portion 35 are all shaped to be capable of collecting the scattering ink.

The left wall portion 31, the right wall portion 32, the front wall portion 33, and the rear wall portion 34 are disposed between the upper wall portion 35 and the lower wall portion 36 in the carriage 30. The Z-axis direction dimension of the left wall portion 31, the Z-axis direction dimension of the right wall portion 32, and the Z-axis direction dimension of the rear wall portion 34 are the same. The Z-axis direction dimension of the front wall portion 33 is shorter than the Z-axis direction dimension of any of the left wall portion 31, the right wall portion 32, and the rear wall portion 34. As a result, an end 33a of the front wall portion 33 on the +Z direction side is positioned at a position that is in the −Z direction from an end 31a of the left wall portion 31 on the +Z direction side.

The Z-axis direction dimension of the front wall portion 33 is shorter than the Z-axis direction dimension of any of the left wall portion 31, the right wall portion 32, and the rear wall portion 34. Further, the end 33a of the front wall portion 33 on the +Z direction side is positioned lower than the end 31a of the left wall portion 31 on the +Z direction side. On the +Y direction side of the carriage 30, a gap is formed between the front wall portion 33 supported by the left wall portion 31 and the right wall portion 32 and the upper wall portion 35.

The user can observe the state of the ink tank 71 accommodated in the carriage 30 and the state of the ink E reserved in the tank main body portion 72 through the gap.

An opening (not shown) is provided in the lower wall portion 36. In a state of being fitted into the opening of the lower wall portion 36, the head 26 is fixed to the lower wall portion 36. If the head 26 is fitted into the opening of the lower wall portion 36, the surface on the −Z direction side of the head 26, that is, the nozzle surface 28 on which the nozzle 27 is formed, protrudes from the lower wall portion 36 on the −Z direction side and is disposed to face the paper sheet S supported by the second support member 22.

The upper wall portion 35 covers the +Z direction with respect to the supply port 74. That is, the upper wall portion 35 overlaps with the supply port 74 of the tank main body portion 72 in a plan view as viewed from a position that is in the +Z direction from the upper wall portion.

The ink tank 71 is protected by the upper wall portion 35 in the +Z direction so that an extra force hardly acts on the cap member 75 in the +Z direction with respect to the supply port 74.

The upper wall portion 35 is supported by the left wall portion 31 and the right wall portion 32 on the +Y direction side of the carriage 30. Specifically, the upper wall portion 35 has a pair of curved portions in contact with the left wall portion 31 and the right wall portion 32 on the +Y direction side. The upper wall portion 35 is supported by the left wall portion 31 and the right wall portion 32 by the pair of curved portions and is configured to pivot at least in the Z-axis direction with the pair of curved portions as a fulcrum. That is, the upper wall portion 35 is configured to pivot at least in the Z-axis direction with the end on the +Y direction side as a fulcrum, and the user can pivot the upper wall portion 35 and dispose the upper wall portion 35 in the covering position P3 or the open position P4.

Further, the upper wall portion 35 has an opening portion 35a on the +Y direction side. The user can observe the state of the ink tank 71 accommodated in the carriage 30 and the state of the ink E reserved in the tank main body portion 72 through the opening portion 35a.

The supply port 74 of the tank main body portion 72 and the left wall portion 31 overlap with each other in a plan view as viewed in the X-axis direction. That is, in the printer 1 according to the present embodiment, the supply port 74 of the tank main body portion 72 and the left wall portion 31 overlaps with each other as viewed in the X-axis direction as a direction in which the carriage 30 moves.

The ink tank 71 includes the cap member 75. The cap member 75 is inserted into the supply port 74. At least a part of the cap member inserted into the supply port 74 protrudes from the recessed portion 73. The part of the cap member 75 protruding from the recessed portion 73 overlaps with the left wall portion 31 in a plan view as viewed in the X-axis direction. That is, in the printer 1 according to the present embodiment, the part of the cap member 75 protruding from the recessed portion 73 and the left wall portion 31 overlap with each other as viewed in the X-axis direction as a direction in which the carriage 30 moves.

Further, the supply port 74 of the tank main body portion 72 and the right wall portion 32 overlap with each other in a plan view as viewed in the X-axis direction. That is, in the printer 1 according to the present embodiment, the supply port 74 of the tank main body portion 72 and the right wall portion 32 overlaps with each other as viewed in the X-axis direction in which the carriage 30 moves.

Further, the part of the cap member 75 protruding from the recessed portion 73 overlaps with the right wall portion 32 in a plan view as viewed from the X-axis direction. That is, in the printer 1 according to the present embodiment, the part of the cap member 75 protruding from the recessed portion 73 and the right wall portion 32 overlap with each other as viewed in the X-axis direction in which the carriage 30 moves.

In the present embodiment, viewing in an axis direction means viewing in any direction along the axis direction.

FIG. 4 shows a standby state of the printer 1 not performing recording onto the paper sheet S.

As shown in FIG. 4, when the printer 1 does not perform recording on the paper sheet S, the carriage 30 transitions into a standby state at a home position HP. The home position HP is in the −X direction from an area SA through which the paper sheet S passes. That is, the standby position of the carriage 30 when the printer 1 does not perform the recording on the paper sheet S is the home position HP.

As described above, the printer 1 alternately repeats the operation of ejecting the ink E onto the paper sheet S from the nozzle 27 while moving the carriage 30 in the X direction and the operation of moving the paper sheet S in the transport direction and records an image on the paper sheet S.

When the printer 1 records an image on the paper sheet S, the printer 1 moves the carriage 30 in the home position HP in the +X direction and continuously moves the paper sheet S in the +Y direction. The movement of the carriage 30 and the movement of the paper sheet S are alternately repeated and an image is recorded on the paper sheet S.

When the carriage 30 is disposed in the home position HP, a maintenance device 56 is disposed at a position that is in the −Z direction from the carriage 30. The maintenance device 56 includes a cap 57. The cap 57 is disposed opposite to the head 26 of the carriage 30 in the home position HP. The cap 57 is configured to move in the Z-axis direction. When the carriage 30 is on standby in the home position HP, the cap 57 moves in the +Z direction and comes into contact with the nozzle surface 28. Contacting with the nozzle surface 28 by the cap 57 and enclosing the nozzle 27 by an edge of the cap 57 constitute a capping processing of the head 26 by the cap 57. Viscosity increase of the ink E in the head 26 is suppressed by the capping processing. Further, when the printer 1 records an image on the paper sheet S, the cap 57 moves in the −Z direction.

Further, the maintenance device 56 executes a maintenance processing of restoring the head 26 to a normal state such as a flushing processing of forcibly discharging from the head 26 the ink E of increased whose viscosity is increased or the ink E into which air bubbles are mixed and a wiping processing of removing dirt adhering to the nozzle surface 28 of the head 26.

In this way, the maintenance device 56 executes the capping processing and the maintenance processing of restoring the head 26 to a normal state. Further, the cap 57 moves in the Z-axis direction in the capping processing and the flushing processing.

FIG. 6 is a sectional view taken along line VI-VI of FIG. 4 and is a schematic view showing a state of the ink jet printer according to the present embodiment. FIG. 6 shows the ink E spilling when the ink E is supplied to the tank main body portion 72.

The second support member 22, the paper sheet S, the carriage 30, the head 26, the ink tank 71, and the cap 57 are schematically shown in FIG. 6, and illustrations of other components are omitted. The carriage 30, the head 26, and the ink tank 71 are denoted by solid lines when disposed in an ink supply position RP and by two-dot chain lines when disposed in the home position HP.

As shown in FIG. 6, the nozzle surface 28 of the carriage 30 in the home position HP is in a position different from the position of the second support member 22 in the X-axis direction. As described above, since the second support member 22 is configured to support the paper sheet S transported by the transporter 40, the paper sheet disposition area SA in which the second support member 22 configured to support the paper sheet S is an area through which the paper sheet S transported by the transporter 40 passes. That is, in a state where the carriage 30 is positioned in the home position HP, the nozzle surface 28 faces the outside of the area SA.

When the ink E reserved in the tank main body portion 72 is reduced and the ink E is supplied from the supply port 74 into the tank main body portion 72, the controller 60 moves the carriage 30 to the ink supply position RP. In a state where the carriage 30 is positioned in the ink supply position RP, the user supplies ink into the tank main body portion 72 of the ink tank 71 mounted on the carriage 30. As shown in FIG. 6, in a state where the carriage 30 is positioned in the ink supply position RP, the nozzle surface 28 faces the outside of the area SA. Further, the nozzle surface 28 in a state where the carriage 30 is positioned in the ink supply position RP is positioned, in the X-axis direction, between the area SA and the nozzle surface 28 in a state where the carriage 30 is positioned in the home position HP. That is, the area SA is positioned at a position that is in the +X direction from the nozzle surface 28 in a state where the carriage 30 is positioned in the ink supply position RP. Therefore, in the direction in which the carriage 30 moves, the direction from the supply port 74 toward the left wall portion 31 as the first wall portion and the direction from the nozzle surface 28 of the carriage 30 positioned in the ink supply position RP toward the area SA are the same.

Specifically, when supplying the ink E into the tank main body portion 72, the user selects an ink supply button in the operation panel 15 shown in FIG. 4, and disposes the maintenance cover 14 shown in FIG. 4 in the open position P2 thereafter. If the controller 60 detects disposition of the maintenance cover 14 in the open position P2 by a sensor (not shown) in a state where the ink supply button in the operation panel 15 is selected, the controller 60 moves the carriage 30 to the ink supply position RE. The user disposes the upper wall portion 35 in the open position P4 subsequently and detaches the cap member 75 from the supply port 74. Then, the user supplies the ink E from the supply port 74 into the tank main body portion 72, using a supply container filled with the ink E.

If the supply of the ink E to the tank main body portion 72 is over, the user attaches the cap member 75 to the supply port 74, disposes the upper wall portion 35 in the covering position P3, disposes the maintenance cover 14 in the covering position P1, and selects a supply completion button in the operation panel 15. If the supply completion button in the operation panel 15 is selected in a state where the disposition of the maintenance cover 14 in the covering position P1 is detected by the sensor (not shown), the controller 60 moves the carriage 30 from the ink supply position RP to the home position HP, and recording on the paper sheet S is resumed in a state where the carriage 30 (the head 26 and the ink tank 71) is disposed in the home position HP.

In the present embodiment, if the disposition of the maintenance cover 14 in the open position P2 is detected in a state where a predetermined button in the operation panel 15 is selected, the controller 60 moves the carriage 30 to the ink supply position RP, but the present disclosure is not limited thereto. When there is any action associated with the supply of the ink E into the tank main body portion 72, the controller 60 may move the carriage 30 to the ink supply position RP. For example, the controller 60 may be configured to move the carriage 30 to the ink supply position RP when a predetermined button in the operation panel 15 is selected. Further, the controller 60 may be configured to move the carriage 30 to the ink supply position RP when the disposition of the maintenance cover 14 in the open position P2 is detected. Further, the controller 60 may be configured to move the carriage 30 to the ink supply position RP when the ink E inside the tank main body portion 72 falls below a predetermined threshold value.

As described above, the nozzle surface 28 when the carriage 30 is positioned in the ink supply position RP is positioned, in the X-axis direction as a moving direction of the carriage 30, between the area SA through which the paper sheet S passes and the nozzle surface 28 of the carriage 30 positioned in the home position HP. Further, when the carriage 30 is positioned in the ink supply position RP, the ink E is supplied from the supply port 74 to the tank main body portion 72 by the user. More specifically, using a supply container filled with the ink E, the user inserts a tip end of the supply container into the supply port 74 and supplies the ink E to the tank main body portion 72. That is, supply of the ink E is executed by the user in a state where the nozzle surface 28 is positioned in a position different from the area SA through which the paper sheet S passes and from the position of the cap 57 in the moving direction of the carriage 30.

There is a concern that the ink E leaks from the nozzle 27 when the ink E is supplied to the tank main body portion 72. If the ink E leaking from the nozzle 27 drops in a state where the nozzle surface 28 faces the area SA, the ink E is stuck to a part of the second support member 22 on which the paper sheet S passes or the paper sheet S supported by the second support member and the paper sheet S gets contaminated. In the present embodiment, since the supply of the ink E to the tank main body portion 72 is performed in a state where the nozzle surface 28 does not face the area SA, the concern that the paper sheet S gets contaminated is alleviated.

Further, there is a concern that the tank main body portion 72 gets pressed in the −Z direction by a supply container used by the user and the whole carriage 30 including the nozzle surface 28 gets pressed in the −Z direction when the ink E is supplied to the tank main body portion 72. There is a concern that, if the supply of the ink E to the tank main body portion 72 is performed when the carriage 30 is positioned in the home position HP, in other words, when the cap 57 faces the nozzle surface 28, the nozzle surface 28 pressed in the −Z direction contacts with the cap 57 and an excessive load is applied to the cap 57. In the present embodiment, since the supply of the ink E to the tank main body portion 72 is performed in a state where the nozzle surface 28 does not face the cap 57, that is, the carriage 30 is not position in the home position HP, the concern that an excessive load is applied to the cap 57 is alleviated.

When the ink E is supplied into the tank main body portion 72, that is, when the carriage 30 is positioned in the ink supply position RP, the left wall portion 31 is positioned at a position that is in the +X direction from the supply port 74 of the tank main body portion 72 and the right wall portion 32 is positioned at a position that is in the −X direction from the supply port 74 of the tank main body portion 72. That is, the left wall portion 31 is disposed between the paper sheet S and the tank main body portion 72 in the moving direction of the carriage 30.

When the supply of the ink E to the tank main body portion 72 is over and the recording on the paper sheet S is resumed, that is, when the carriage 30 is positioned in the home position HP, the left wall portion 31 is disposed at a position that is in the +X direction from the supply port 74 of the tank main body portion 72 and the right wall portion 32 is positioned at a position that is in the −X direction side from the supply port 74 of the tank main body portion 72. Therefore, when a first scan is performed from the home position HP, the right wall portion 32 is disposed at a position that is in a opposite direction from the supply port 74 of the tank main body portion 72, the opposite direction being opposite to the moving direction of the carriage 30 in the first scan.

If the tip end of a supply container is not properly inserted into the supply port 74 of the tank main body portion 72 when the ink E is supplied into the tank main body portion 72, the ink E spills from the supply port 74 sometimes. In the present embodiment, since the recessed portion 73 is provided on the surface 72a on the +Z direction side of the tank main body portion 72, the ink E spilling from the supply port 74 is reserved inside the recessed portion 73 and hardly spreads outside the recessed portion 73. Therefore, problems like contamination by the ink E and a breakdown of various members accommodated inside the printer case 12 hardly arise.

Further, there is a concern that, when a user supplies the ink E into the tank main body portion 72, the ink E scatters in the vicinity of the supply port 74 by an inappropriate insertion of the tip end of the supply container into the supply port 74 of the tank main body portion 72 or by pulling-out of the tip end of the supply container from the supply port 74 after the ink supply to the tank main body portion 72 is over.

In the present embodiment, the X-axis direction is a moving direction of the carriage 30, and the +X direction and the -X direction are along the X-axis direction. The left wall portion 31 is provided at a position that is in the +X direction from the supply port 74. The right wall portion 32 is provided at a position that is in the −X direction side from the supply port 74. Then, the left wall portion 31 and the right wall portion 32 overlap with the supply port 74 as viewed in the X-axis direction. Therefore, since either the left wall portion 31 or the right wall portion 32 is provided in either moving direction of the carriage 30 with respect to the supply port 74, it is possible to reduce scattering of the ink E in either moving direction of the carriage 30.

Further, in the present embodiment, when the carriage 30 is positioned in the ink supply position RP, in the direction in which the carriage 30 moves, the direction from the nozzle surface 28, having the nozzle 27 with which the tank main body portion 72 communicates, toward the region SA and the direction from the supply port 74 toward the left wall portion 31 are the same. Therefore, since the left wall portion 31 is disposed between the paper sheet S and the tank main body portion 72 when the ink E is supplied into the tank main body portion 72, the ink E scattering in the vicinity of the supply port 74 is captured by the left wall portion 31 and the paper sheet S is hardly contaminated. That is, since the left wall portion 31 which is positioned at a position that is in the +X direction from the supply port 74 and which overlaps with the supply port 74 as viewed in the X-axis direction is provided, the paper sheet S hardly gets contaminated by the ink E even if the ink E scatters when a user supplies the ink E into the tank main body portion 72.

When the supply of the ink E to the tank main body portion 72 is over and the recording on the paper sheet S is resumed, the carriage 30 in the home position HP is moved to the area SA as the first scan of the carriage 30.

If the first scan of moving the carriage 30 in the +X direction, which is toward the area SA, is executed in a state where the ink E is reserved in the recessed portion 73, the ink E reserved inside the recessed portion 73 scatters in the -X direction opposite to the +X direction as the moving direction of the carriage 30 in the first scan, in other words, in the direction from the area SA toward the nozzle surface 28 of the carriage 30 positioned in the ink supply position RP in the direction in which the carriage 30 moves.

In the present embodiment, when the carriage 30 is positioned in the ink supply position RP, in the direction in which the carriage 30 moves, the direction from the area SA toward the nozzle surface 28 having the nozzle 27 with which the tank main body portion 72 communicates and the direction from the supply port 74 toward the right wall portion 32 are the same. The supply port 74 and the right wall portion 32 overlap with each other as viewed in the X-axis direction as a direction in which the carriage 30 moves. Therefore, since the right wall portion 32, which is positioned at a position that is in an opposite direction from the supply port 74, the opposite direction being opposite to the moving direction of the carriage 30 in the first scan, further, which overlaps with the supply port 74 in a plan view as viewed in the X-axis direction as a direction in which the carriage 30 moves, is provided, the scattering ink E is captured by the right wall portion 32 provided in the direction in which the ink E easily scatters with respect to the supply port 74 even when the ink E reserved inside the recessed portion 73 scatters in the first scan of the carriage 30. As a result, contamination by the ink E is suppressed and contamination of various members accommodated inside the printer case 12 and contamination of the paper sheet S hardly occurs.

Further, in the present embodiment, of the X-axis direction as a direction in which the carriage 30 moves, the left wall portion 31 is provided at a position that is in the +X direction from the supply port 74 and the right wall portion 32 is provided at a position that is in the −X direction from the supply port 74. Therefore, in the moving direction of the carriage 30, the right wall portion 32 is provided at a position that is in the direction, opposite to the direction from the supply port 74 toward the left wall portion 31, from the supply port 74. In other words, in the moving direction of the carriage 30, the left wall portion 31 is provided at a position that is in the direction, opposite to the direction from the supply port 74 toward the right wall portion 32, from the supply port 74. According to this, the concern that the paper sheet S gets contaminated by the scattering of the ink E and the concern that the inside of the printer case 12 gets contaminated by the scattering of the ink E inside the recessed portion 73 at the time of the first scan of the carriage 30 after recording is assumed are alleviated.

### Embodiment 2

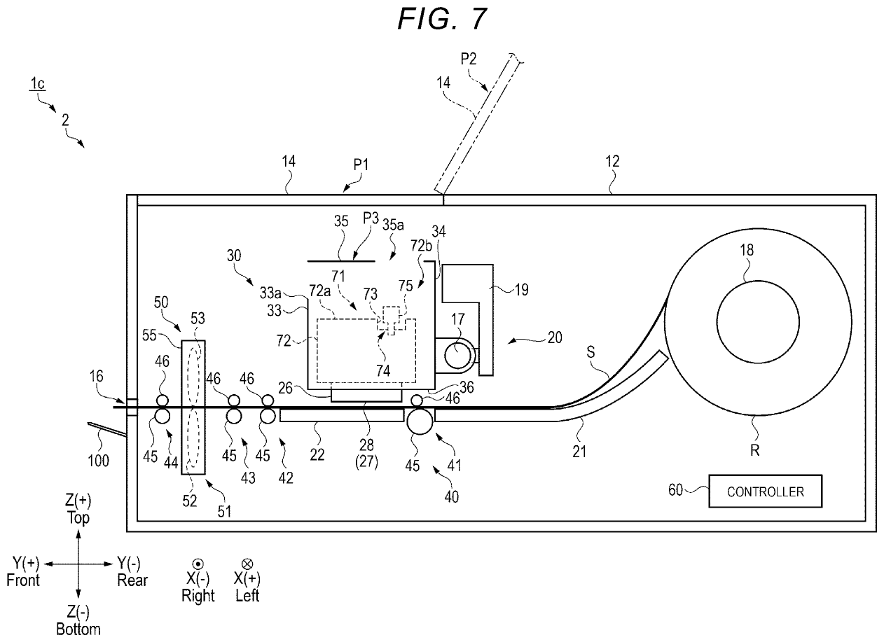

FIG. 7 is a view corresponding to FIG. 3 and is a schematic view showing a configuration of an ink jet printer according to an embodiment 2.

In the printer 1C according to the present embodiment and the printer 1 according to the embodiment 1, the positions of the opening portion 35a provided in the upper wall portion 35 are different. Specifically, compared with the printer 1 according to the embodiment 1, the opening portion 35a is provided on the −Y direction side of the upper wall portion 35 in the printer 1C according to the present embodiment. This point is a main difference between the present embodiment and the embodiment 1.

In the following, an outline of the printer 1C in the present embodiment will be described with reference to FIG. 7, focusing on differences from the embodiment 1. The components same as in the embodiment 1 will be given the same reference numerals and repetitive descriptions will be omitted.

As shown in FIG. 7, the opening portion 35a is provided on the −Y direction side of the upper wall portion 35 in the carriage 30. Further, when the carriage 30 is positioned in the ink supply position RP, the printer 1C according to the present embodiment includes a case opening portion 14a positioned in the +Z direction of the carriage 30 positioned in the ink supply position RP.

Further, the maintenance cover 14 is configured to move to the covering position P1 in which the case opening portion 14a is covered and the open position P2 different from the covering position P1. In addition, the printer 1C according to the present embodiment, like the printer 1 according to the embodiment 1, includes a transporter 40 transporting the paper sheet S onto which the ink E is ejected and a controller 60 controlling the movement of the carriage 30. When the ink is supplied from the supply port 74 to the tank main body portion 72, the controller 60 moves the carriage 30 to the ink supply position RP.

When the upper wall portion 35 is in the covering position P3, the cap member 75 and the supply port 74 of the tank main body portion 72, and the opening portion 35a of the upper wall portion 35 overlap with each other in a plan view as viewed from a position that is in the +Z direction from the upper wall portion. That is, when the upper wall portion 35 is in the covering position P3, the cap member 75 and the supply port 74 of the tank main body portion 72 are exposed by the opening portion 35a. In other words, if the carriage 30 is accessible to a user from the +Z direction, the user can access the cap member 75 and the supply port 74 even in a state where the upper wall portion 35 is in the covering position P3. Therefore, if the maintenance cover 14 is positioned in the open position P2, that is, if the maintenance cover 14 is opened, the cap member 75 and the supply port 74 of the tank main body portion 72 are exposed through the case opening portion 14a and the user can access the cap member 75 and the supply port 74 of the tank main body portion 72 regardless of whether the upper wall portion 35 is in the covering position P3 or in the open position P4.

That is, in the printer 1C according to the present embodiment, when the maintenance cover 14 is in the open position P2, the user can access the cap member 75 and the supply port 74 regardless of the state of the upper wall portion 35.

When the ink E reserved in the tank main body portion 72 is reduced and the ink E is supplied from the supply port 74 into the tank main body portion 72, the user selects the ink supply button in the operation panel 15 and disposes the maintenance cover 14 in the open position P2 thereafter. If the disposition of the maintenance cover 14 in the open position P2 is detected by a sensor (not shown) in a state where the ink supply button in the operation panel 15 is selected, the controller 60 moves the carriage 30 to the ink supply position RP. Subsequently, the user detaches the cap member 75 from the supply port 74 and uses the supply container filled with the ink E to supply the ink E into the tank main body portion 72.

If the supply of the ink E to the tank main body portion 72 is over, the user attaches the cap member 75 to the supply port 74, disposes the maintenance cover 14 in the covering position P1, and selects the supply completion button in the operation panel 15. When the supply completion button in the operation panel 15 is selected in a state where the disposition of the maintenance cover 14 in the covering position P1 is detected by a sensor (not shown), the controller 60 moves the carriage 30 from the ink supply position RP to the home position HP and resumes the recording on the paper sheet S.

In the present embodiment, if the maintenance cover 14 is opened, the user can access the cap member 75 and the supply port 74 of the tank main body portion 72 regardless of the state of the upper wall portion 35. Accordingly, the user can supply the ink E into the tank main body portion 72 just by opening the maintenance cover 14 only. Further, if the supply of the ink E to the tank main body portion 72 is over, the user may just close the maintenance cover 14 only.

In this way, in the present embodiment, only the maintenance cover 14 may be opened when the ink E is supplied into the tank main body portion 72 and only the maintenance cover 14 may be closed if the supply of the ink E into the tank main body portion 72 is over.

On the other hand, in the embodiment 1, both the maintenance cover 14 and the upper wall portion 35 need opening when the ink E is supplied into the tank main body portion 72, and both the maintenance cover 14 and the upper wall portion 35 need closing if the supply of the ink E to the tank main body portion 72 is over.

Accordingly, since the upper wall portion 35 may not be opened and closed in the present embodiment when the ink E reserved in the tank main body portion 72 is reduced and the ink E is supplied into the tank main body portion 72, burden of the user in supplying the ink E into the tank main body portion 72 is alleviated, compared with the embodiment 1 in which the upper wall portion 35 is opened and closed.

The present disclosure is not limited to the above embodiments and can be appropriately modified within a scope not contrary to the gist or ideas of the disclosure read from the scope of the appended claims and the entire specification, and various modification examples other than the above embodiments are conceivable. In the following, modification examples will be described.

### MODIFICATION EXAMPLE 1

In the embodiment described above, the recessed portion 73 is provided on the surface 72a on the +Z direction side of the tank main body portion 72 in which the ink E is reserved and the supply port 74, through which the ink E is supplied, is provided in the recessed portion 73.

Contrary to the embodiments described above, a protruding portion may be provided on the surface 72a on the +Z direction side of the tank main body portion 72 in which the ink E is reserved and the supply port 74, through which the ink E is supplied, may be provided in the protruding portion. The user easily locates the supply port 74 using the protruding portion as a mark and the user easily inserts the tip end (supply port) of the supply container supplying the ink E into the supply port 74 of the tank main body portion 72. Accordingly, when the supply port 74 is provided in the protruding portion, a problem of not appropriately supplying the ink E into the tank main body portion 72 hardly occurs.

In the plan view as viewed in the X-axis direction, the protruding portion in which the supply port 74 is provided, and the left wall portion 31 and the right wall portion 32 overlap with each other. Even when the problem of not appropriately supplying the ink E into the tank main body portion 72 occurs, the ink E scattering from the supply port 74 is captured by the left wall portion 31 or the right wall portion 32 and an adverse impact (contamination of a member, contamination paper sheet S, and the like) of scattering of the ink E hardly occurs. Further, even when the ink E spills from the supply port 74 and the spilled ink E scatters in the X-axis direction by a main scan, the ink E scattering in the X-axis direction is captured by the left wall portion 31 or the right wall portion 32 and an adverse impact of scattering of the ink E hardly occurs.

In this way, a configuration may be such that a protruding portion is provided on the surface 72a on the +Z direction side of the tank main body portion 72 in which the ink E is reserved, that the supply port 74 is provided in the protruding portion, and that the protruding portion provided in the supply port 74, and the left wall portion 31 and the right wall portion 32 overlap with each other in the plan view as viewed from a position that is in the X-axis direction from the carriage 30.

### MODIFICATION EXAMPLE 2

In the embodiments described above, the ink tank 71 has the tank main body portion 72 and the cap member 75, and the cap member 75 is inserted into the supply port 74 of the tank main body portion 72.

Contrary to the embodiment described above, a valve preventing a backflow of the ink E or an intrusion of the outside atmosphere may be provided in the supply port 74 of the tank main body portion 72.

Further, a configuration may be such that the cap member 75 is not provided in the supply port 74 of the tank main body portion 72. For example, it is possible to omit the cap member 75 by adding a water-soluble organic solvent to the ink E to make it difficult to evaporate moisture from the ink E. For example, it is possible to omit the cap member 75 by enhancing the airtightness of the carriage 30.

### MODIFICATION EXAMPLE 3

Compared with the embodiment described above, the upper wall portion 35 may be omitted and the carriage 30 may be configured to have the left wall portion 31 disposed on the +X direction side, the right wall portion 32 disposed on the −X direction side, the front wall portion 33 disposed on the +Y direction side, the rear wall portion 34 disposed on the −Y direction side, and the lower wall portion 36 disposed in the −Z direction side.

If the upper wall portion 35 is omitted, the user can open the maintenance cover 14 only, detach the cap member 75, and supply the ink E into the tank main body portion 72 through the supply port 74 when supplying the ink E into the tank main body portion 72. Then, compared with the embodiment 1 in which both the maintenance cover 14 and the upper wall portion 35 are opened, the cap member 75 is detached, and the ink E is supplied into the tank main body portion 72 through the supply port 74, it is possible to alleviate the burden of the user when the ink E is supplied into the tank main body portion 72.

### MODIFICATION EXAMPLE 4

In the embodiment described above, the guide shaft 17 is of a straight line shape, extending in the X-axis direction as the width direction of the paper sheet S.

For example, the guide shaft 17 may be configured to have a linear portion extending in the X-axis direction and a curved portion curved in a direction different from the X-axis direction. For example, the guide shaft 17 may have a linear guide shaft extending in the X-axis direction and an arc-shaped guide shaft extending in the X-axis direction in an arc shape. Further, the guide shaft 17 may be of a circular shape moving the head 26 in a circumferential direction.

In the following, contents derived from the embodiments described above will be described.

The inkjet printer according to the present disclosure includes a head having a nozzle from which ink is ejected, an ink reservoir in which the ink supplied to the head is reserved, and a carriage on which the head and the ink reservoir are mounted. The carriage has a first wall portion positioned at a position that is in a first direction from a supply port through which the inside of the ink reservoir and the outside of the ink reservoir communicate with each other, the first direction being along a direction in which the carriage moves. And the supply port and the first wall portion overlap with each other as viewed in the direction in which the carriage moves.

When unnecessary ink adheres to the supply port of the ink reservoir and the ink reservoir moves together with the carriage, there is a concern that the unnecessary ink scatters in the first direction out of the moving directions of the carriage to contaminate a medium.

Since the carriage has the first wall portion positioned at the first direction side with respect to the supply port and the supply port and the first wall portion overlap with each other as viewed from the moving direction of the carriage, the unnecessary ink scattering in the first direction is captured by the first wall portion and the medium hardly gets contaminated.

The ink jet printer according to the present disclosure includes a transporter configured to transport the medium onto which the ink is ejected and a controller configured to control a movement of the carriage. Further, the controller is configured to control the carriage to move to an ink supply position when the ink is supplied through the supply port to the ink reservoir, and the area through which the medium transported by the transporter passes is positioned at a position that is in the first direction from the nozzle surface of the head in a state where the carriage is positioned in the ink supply position.

It is necessary to supply the ink from the supply port to the ink reservoir when the ink is ejected from the head and the ink is consumed. The supply of the ink to the ink reservoir is executed in the ink supply position outside the area through which the medium passes, and the medium is not disposed in the ink supply position. Then, even if the ink spills and drops from the supply port when the ink is supplied to the ink reservoir in the ink supply position, since the medium is not disposed in the ink supply position, the ink spilling from the support port hardly contaminates the medium.

Further, if the area through which the medium passes is positioned at the first direction side of the nozzle surface in a state where the carriage is positioned in the ink supply position, the nozzle surface (ink reservoir), the first wall portion, and the medium are sequentially arranged in the first direction, and the first wall portion is disposed between the ink reservoir and the medium. Then, even if the ink scatters in the first direction when the ink is supplied from the supply port to the ink reservoir, the ink scattering in the first direction is captured by the first wall portion and the medium is hardly contaminated.

The ink jet printer according to the present disclosure includes the transporter configured to transport the medium onto which the ink is ejected and the controller configured to control the movement of the carriage. Further, the controller is configured to control the carriage to move to the ink supply position when the ink is supplied through the supply port to the ink reservoir, and the nozzle surface is positioned at a position that is in the first direction from the area through which the medium transported by the transporter passes in a state where the carriage is positioned in the ink supply position.

It is necessary to supply ink from the supply port to the ink reservoir when the ink is ejected from the head and the ink is consumed. The supply of ink to the reservoir is executed in the ink supply position outside the area through which the medium passes, and the medium is not disposed in the ink supply position. Then, even if the ink spills and drops when the ink is supplied to the ink reservoir in the ink supply position, the ink spilling from the supply port hardly contaminates the medium.

Further, if the nozzle surface is positioned at the first direction side of the area through which the medium passes in a state where the carriage is positioned in the ink supply position, the medium, the nozzle surface (ink reservoir), and the first wall portion are sequentially arranged in the first direction. Then, when unnecessary ink adheres to the supply port of the ink reservoir and the ink reservoir moves together with the carriage, the unnecessary ink scattering in the first direction is captured by the first wall portion and the medium hardly gets contaminated.

In the ink jet printer according to the present disclosure, the carriage has the second wall portion positioned at a position that is in the second direction from the supply port, the second direction being opposite to the first direction out of the directions and along the carriage moves and the supply port and the second wall portion overlap with each other as viewed in the direction in which the carriage moves.

When unnecessary ink adheres to the supply port of the ink reservoir and the ink reservoir moves together with the carriage, the unnecessary ink scatters in the second direction out of the moving directions of the carriage and the medium hardly gets contaminated.

Since the carriage has the second wall portion positioned at the side of the second direction opposite to the first direction with respect to the supply port and the supply port and the second wall portion overlap with each other as viewed from the moving direction of the carriage, the unnecessary ink scattering in the second direction is captured by the second wall portion and the medium hardly gets contaminated.

In the ink jet printer according to the present disclosure, the carriage has a lid member covering a vertically upper side with respect to the supply port.

Since the ink reservoir is covered by the lid member and protected by the lid member in the vertical direction with respect to the supply port, an unnecessary force hardly acts on the ink reservoir and a foreign matter hardly intrudes from a vertically upper side with respect to the supply port.

The ink jet printer according to the present disclosure includes the controller configured to control the carriage to move to the ink supply position when the ink is supplied from the supply port to the ink reservoir, a printer case having an opening portion vertically above the carriage positioned in the ink supply position, and a printer cover provided on the printer case and configured to move to the covering position and the open position. The carriage has the lid member covering the vertically above the supply port, and the supply port is positioned so that a user can access the supply port regardless of the state of the lid member when the printer cover is in the open position.

The printer cover is closed in the covering position so that the opening portion is hidden. The printer cover is open so that the opening portion is exposed.

Further, the opening portion is provided vertically above the carriage in a state where the carriage is in the ink supply position. When the carriage has a lid member covering the vertically upper side with respect to the supply port, that is, when the carriage has a lid member covering the vertically upper side, the opening portion is provided in the lid member. Further, if the opening portion is provided such that the supply port is exposed regardless of the state of the lid member, a user can access the supply port when the printer cover is in the open state.

In this way, in the present disclosure, when the printer cover is in the open state, the opening portion enables the user to access the supply port regardless of the state of the lid member.

It is necessary to supply the ink from the supply port to the ink reservoir when the ink is ejected from the head and the ink is consumed.

Since the user can access the supply port regardless of the state of the lid member when the printer cover is in the open position, the user can supply the ink to the ink reservoir in a state where the printer cover is opened.

If an opening portion is not provided so that the supply port is exposed and the lid member is provided so that the supply port is covered, the user needs to open both the printer cover and the lid member when supplying the ink to the ink reservoir.

The present disclosure needs to open the printer cover only when the ink is supplied to the ink reservoir, and the burden of the user is alleviated as compared with the state in which both the printer cover and the lid member are opened.

In the ink jet printer according to the present disclosure, the ink reservoir has a protruding portion on an upper surface in the vertical direction, the supply port is provided in the protruding portion, the protruding portion and the first wall portion overlap with each other as viewed in the direction in which the carriage moves, and the protruding portion and the second wall portion overlap with each other as viewed in the direction in which the carriage moves.

If a protruding portion is provided on an upper surface of the ink reservoir in the vertical direction and the supply port is provided in the protruding portion, the protruding portion serves as a mark and the supply port is easily located. If the supply port is easily located, it becomes easy to appropriately supply the ink to the ink reservoir.

In the ink jet printer according to the present disclosure, the ink reservoir has a recessed portion on the upper surface in the vertical direction, and the supply port is provided in the recessed portion.

If a recessed portion is provided on the upper surface of the ink reservoir in the vertical direction and the supply port is provided in the recessed portion, the recessed portion serves as a receptacle of the ink spilling from the supply port and the ink spilling from the supply port hardly spreads outside the recessed portion.

The ink jet printer according to the present disclosure include the cap member which is inserted into the supply port and at least a part of which protrudes from the recessed portion, and the part of the cap member protruding from the recessed portion and the first wall portion overlap with each other as viewed in the direction in which the carriage moves.

If the supply port is closed by the cap member, a foreign matter hardly intrudes from the supply port into the ink reservoir. Further, if the supply port is closed by the cap member, a solvent component of the ink hardly evaporates from the supply port and drying of the ink hardly proceeds.

Further, when the ink spilling from the supply port is reserved in the recessed portion and the ink moves together with the carriage and scatters in the first direction, the ink scattering in the first direction is captured by the first wall portion and the medium hardly gets contaminated.

In the ink jet printer according to the present disclosure, the carriage has the third wall portion positioned at a position that is in a third direction from the ink reservoir, the third direction intersecting with the vertical direction and with the direction in which the carriage moves, and it is preferable that an upper end of the third wall portion in the vertical direction is positioned lower than the upper end of the first wall portion in the vertical direction.

If the third wall portion positioned at one side of the direction intersecting with the vertical direction and the moving direction of the carriage, the ink reservoir is in a protected state by the third wall portion on the one side and an unnecessary force hardly acts with respect to the ink reservoir and a foreign matter hardly intrudes from the one side.

Further, if the upper end of the third wall portion in the vertical direction is positioned lower than the upper end of the first wall portion in the vertical direction, a gap is formed between the lid member and the third wall portion and it is possible for the user to observe the state of the ink reservoir mounted on the carriage through the gap.

What is claimed is:

1. An ink jet printer comprising:
a head having a nozzle from which ink is ejected;
an ink reservoir in which the ink supplied to the head is reserved; and
a carriage on which the head and the ink reservoir are mounted configured to move along a guide member, wherein
the carriage has a first wall portion positioned at a position that is in a first direction from a supply port through which an inside of the ink reservoir and an outside of the ink reservoir communicate with each other, the first direction being along a direction in which the carriage moves, and
the supply port and the first wall portion overlap with each other as viewed in the direction in which the carriage moves.

2. The ink jet printer according to claim 1, further comprising:
a transporter configured to transport a medium onto which the ink is ejected; and
a controller configured to control a movement of the carriage, wherein
the controller is configured to control the carriage to move to an ink supply position when the ink is supplied through the supply port to the ink reservoir, and
an area through which the medium transported by the transporter passes is positioned at a position that is in the first direction from a nozzle surface of the head in a state where the carriage is positioned in the ink supply position.

3. The ink jet printer according to claim 1, further comprising:
a transporter configured to transport a medium onto which the ink is ejected; and
a controller configured to control a movement of the carriage, wherein
the controller is configured to control the carriage to move to an ink supply position when the ink is supplied through the supply port to the ink reservoir, and
a nozzle surface of the head is positioned at a position that is in the first direction from an area through which the medium transported by the transporter passes in a state where the carriage is positioned in the ink supply position.

4. The ink jet printer according to claim 1, wherein
the carriage has a second wall portion at a position that is in a second direction from the supply port, the second direction being opposite to the first direction and along the direction in which the carriage moves, and
the supply port and the second wall portion overlap with each other as viewed in the direction in which the carriage moves.

5. The ink jet printer according to claim 1, wherein
the carriage has a lid member covering a vertically upper side with respect to the supply port.

6. The ink jet printer according to claim 1, further comprising:
a controller configured to control the carriage to move to an ink supply position when the ink is supplied from the supply port to the ink reservoir;
a printer case having an opening portion vertically above the carriage positioned in the ink supply position; and
a printer cover that is provided on the printer case and that is configured to move to a covering position in which the opening portion is covered and an open position different from the covering position, wherein
the carriage has a lid member positioned vertically above the supply port, and
the supply port is positioned so that a user is able to access the supply port regardless of a state of the lid member when the printer cover is in the open position.

7. The ink jet printer according to claim 4, wherein
the ink reservoir has a protruding portion on a vertically upper surface,
the supply port is provided on the protruding portion,
the protruding portion and the first wall portion overlap with each other in the direction in which the carriage moves, and
the protruding portion and the second wall portion overlap with each other as viewed in the direction in which the carriage moves.

8. The ink jet printer according to claim 1, wherein
the ink reservoir has a recessed portion on a vertically upper surface, and
the supply port is provided in the recessed portion.

9. The ink jet printer according to claim 8, further comprising:
a cap member which is inserted into the supply port and at least a part of which protrudes from the recessed portion, wherein
a part of the cap member protruding from the recessed portion and the first wall portion overlap with each other as viewed in the direction in which the carriage moves.

10. The ink jet printer according to claim 1, wherein
the carriage has a third wall portion positioned at a position that is in a third direction from the ink reservoir, the third direction intersecting with a vertical direction and with the direction in which the carriage moves, and
a vertically upper end of the third wall portion is positioned lower than a vertically upper end of the first wall portion.
